(19) United States
(12) Patent Application Publication
(10) Pub. No.: US 2025/0277669 A1
(43) Pub. Date: Sep. 4, 2025

(54) SYSTEM AND METHOD FOR PROCESSING ADDRESS DATA

(71) Applicant: SHOPEE IP SINGAPORE PRIVATE LIMITED, Singapore (SG)

(72) Inventors: Shiping GONG, Shenzhen (CN); Wei HU, Shenzhen (CN); Kezhen ZHAO, Shenzhen (CN); Yingtong HU, Shenzhen (CN); Amanda Ai Shan THNG, Singapore (SG); Zhengyu CHEN, Singapore (SG)

(21) Appl. No.: 19/030,767

(22) Filed: Jan. 17, 2025

(30) Foreign Application Priority Data
Feb. 29, 2024 (SG) 10202400565S

(51) Int. Cl. G01C 21/36

(52) U.S. Cl. CPC G01C 21/3611

(57) ABSTRACT

Provided herein are systems, methods, and computer-readable media for processing an address. An example method for processing an address comprises: obtaining, by at least one processor, an address. Additionally, the method comprises generating location data associated with the address. Moreover, the method comprises obtaining at least one service report based on the location data. Further, the method comprises, determining whether the location data requires refinement based on the at least one service report, and generating an amended location data associated with the address based on determining the location data requires refinement.

### CROSS-REFERENCE TO RELATED APPLICATIONS

This patent application claims the benefit of and priority to Singaporean Non-Provisional patent application Ser. No. 10/202,400565S, filed with the Intellectual Property Office of Singapore on 29 Feb. 2024, entitled “SYSTEM AND METHOD FOR PROCESSING ADDRESS DATA,” the contents of which are incorporated by reference in its entirety and for all purposes.

### TECHNICAL FIELD

Various aspects of this disclosure relate to systems and methods for processing address data, in particular, for refining location data associated with the address data.

### BACKGROUND

The following discussion of the background art is intended to facilitate an understanding of the present disclosure only. It should be appreciated that the discussion is not an acknowledgment or admission that any of the material referred to was published, known, or is part of the common general knowledge of the person skilled in the art in any jurisdiction as of the priority date of the disclosure.

An address is a collection of information or data used to provide or derive the location of landmarks, such as a building or unit in a building. Such information or data may include street names, city, state, or territory names, and codes such as postal codes to make identification easier and aid in locating the landmark.

However, address data formats may be different in different locations, such as different cities. Address formats may also be inconsistently used, and/or may not identify a location with sufficient precision. These differences may cause inaccuracies in generating the associated location data. This causes problems in many fields such as, for example, deliveries, mail, etc. For example, in densely populated areas or some geographical areas, addresses may be incorrect or not be accurate enough to provide a clear indication of a location and, as a result, logistics services and routing services have a difficult time navigating those areas.

While there may exist some services that can provide relatively good geolocation services, these services are relatively expensive and also may not provide accurate enough information.

Accordingly, there exists a need to provide a system and method for processing addresses to mitigate one or more of the aforementioned issues.

### SUMMARY

Various aspects of the disclosure concern a method, and/or system for processing addresses, in particular, to refine location data associated with the addresses that more precisely determines the location of one or more addresses based on one or more location data sources. In some embodiments, the one or more location data sources may include service reports, such as field reports. In some embodiments, the location data may at least include geolocation data. In some embodiments, the geolocation data may be in the form of coordinates. In some embodiments, the field reports may include statuses or service fulfilment reports such as successful parcel deliveries or parcel pickups. In other embodiments, other types of field reports may also be used (e.g., unsuccessful deliveries, unsuccessful pickups, or other crowdsourced reports).

According to an aspect of the disclosure, there is provided a method for processing an address, the method comprising: obtaining, by at least one processor, the address; generating location data associated with the address; obtaining, based on the location data, at least one service report; determining, based on the at least one service report, whether the location data requires refinement; wherein in a positive determination that the location data requires refinement, generating an amended location data associated with the address.

In some embodiments, the method further comprises storing the amended location data in an address database and mapping the amended location data to the address.

In some embodiments, the method further comprises determining a reliability score of the at least one service report before determining whether the location data requires refinement.

In some embodiments, the method further comprises comparing the reliability score of the at least one service report with a threshold, wherein in a positive determination that the reliability score is lower than the threshold, the at least one service report is disregarded.

In some embodiments, the reliability score is generated based on determining an unreliable behavoiur of a service provider associated with the at least one service report, and wherein the unreliable behaviour includes confirming a plurality of address within a unrealistic time period.

In some embodiments, the address is a text address.

In some embodiments, the method further comprises regularizing the text address to a normalized format.

In some embodiments, the location data comprises geolocation data.

In some embodiments, the determining, based on the at least one service report, whether the location data requires refinement is based on at least one of the following: a first location data obtained from a first service provider and a second location data obtained from a second service provider, the first service provider different from the second service provider, a cross-validation of the location data generated by a third-party geolocation system, and a cross-validation of the location data by a plurality of service providers.

In some embodiments, generating location data associated with the address comprises inputting the address to an address reverse geocoding module, the address reverse geocoding module configured to generate the location data associated with the address.

According to another aspect of the present disclosure the is provided a system for processing an address, the system comprises at least one processor configured to: obtain the address; generate location data associated with the address; obtain, based on the location data, at least one service report; determine, based on the at least one service report, whether the location data requires refinement; wherein in a positive determination that the location data requires refinement, generating an amended location data associated with the address.

In some embodiments, the at least one processor is configured to: store the amended location data in an address database and map the amended location data to the address.

In some embodiments, the at least one processor is configured to determine a reliability score of the at least one service report before determining whether the location data requires refinement.

In some embodiments, the at least one processor is configured to compare the reliability score of the at least one service report with a threshold, wherein in a positive determination that the reliability score is lower than the threshold, the at least one service report is disregarded.

In some embodiments, the reliability score is generated based on determining an unreliable behavoiur of a service provider associated with the at least one service report, and wherein the unreliable behaviour includes confirming a plurality of address within a unrealistic time period.

In some embodiments, the address is a text address.

In some embodiments, the at least one processor is configured to regularize the text address to a normalized format.

In some embodiments, the location data comprises geolocation data.

In some embodiments, the determination, based on the at least one service report, whether the location data requires refinement is based on at least one of the following: a first location data obtained from a first service provider and a second location data obtained from a second service provider, the first service provider different from the second service provider, a cross-validation of the location data generated by a third-party geolocation system, and a cross-validation of the location data by a plurality of service providers.

In some embodiments, the at least one processor is configured to generate location data associated with the address by inputting the address to an address reverse geocoding module, the address reverse geocoding module configured to generate the location data associated with the address.

According to another aspect of the present disclosure, there is provided a location data database, the location data database comprising an input module, the input module configured to obtain an address from a user; a service report module, the service report module configured to, based on the address, generate location data associated with the address; obtain, based on the location data, at least one service report; a refinement module configured to: determine, based on the at least one service report, whether the location data requires refinement; wherein in a positive determination that the location data requires refinement, generating an amended location data associated with the address.

In some embodiments, the location database further comprises a network interface configured to interface with at least one of a logistics, mapping and navigation, e-commerce, or social media system.

According to another aspect of the present disclosure, there is provided a computer program element comprising program instructions, which, when executed by one or more processors, cause the one or more processors to perform the aforementioned method.

According to another aspect of the present disclosure, there is provided a computer-readable medium comprising program instructions, which, when executed by one or more processors, cause the one or more processors to perform the aforementioned method.

### BRIEF DESCRIPTION OF THE DRAWINGS

The invention will be better understood with reference to the detailed description when considered in conjunction with the non-limiting examples and the accompanying drawings, in which:

FIG. 1 is a schematic flow chart depicting a method for processing an address;

FIG. 2 is a schematic diagram of a system for processing an address;

FIG. 3A to FIG. 3C illustrates various exemplary methods to determine whether an input location data requires refinement, based on analysis carried out on one or more service reports;

FIG. 4 is a schematic flow diagram illustrating a mapping process of a text address to an output address and geolocation data;

FIGS. 5A to 5C show embodiments of a revision database module, a standard address database module, and a text match database module used for the mapping process of FIG. 4;

FIG. 6A is a flow chart illustrating a method of evaluating an input location data of an address to determine if it is a high confidence location data and address; and

FIG. 6B is a flow chart illustrating a method of evaluating or testing accuracy of an input location data, which may be a service provider's current location or address.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “processor(s),” as used herein, includes one or more electrical circuits capable of processing data, e.g., processing circuits. A processor may include analog circuits or components, digital circuits or components, or hybrid circuits or components. Any other kind of implementation of the respective functions which will be described in more detail below may also be understood as a “circuit” in accordance with an alternative embodiment. A digital circuit may be understood as any kind of a logic implementing entity, which may be special purpose circuitry or a processor executing software stored in a memory, or a firmware.

As used herein, the term “data” may be understood to include information in any suitable analog or digital form, for example, provided as a file, a portion of a file, a set of files, a signal or stream, a portion of a signal or stream, a set of signals or streams, and the like. The term data, however, is not limited to the aforementioned examples and may take some forms and represent any information as understood in the art.

As used herein, the term “location data” refers broadly to any information relating to a geographical point, area, or region. The information may be collected and tracked by a location-based service, such as a mapping application, a GPS satellite in a particular network, for example, a mobile communications carrier. In some embodiments, the location data include geolocation pins, each geolocation pin may comprise coordinates in the form of longitudes and latitudes.

As used herein, the term “service report” refers broadly to any information containing an address, location data associated with the address, and at least one status relating to the fulfilment of a good or service. In some embodiments, the service report may include one or more identifiers and time stamps. A service report may be sent from a service provider to a processor for parsing of the service report to obtain the various data, and for subsequent determination of whether refinement of the location data associated with the address is required.

As used herein, the term “obtain,” as used herein, refers to the processor which actively obtains the inputs, or passively receives inputs from one or more sensors or data source. The term obtain may also refer to a processor, which receives or obtains inputs from a communication interface, e.g., a user interface. The processor may also receive or obtain the inputs via a memory, a register, and/or an analog-to-digital port.

As used herein, the term “module” refers to, or forms part of, or include an Application Specific Integrated Circuit (ASIC); an electrical/electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

In the following, embodiments will be described in detail.

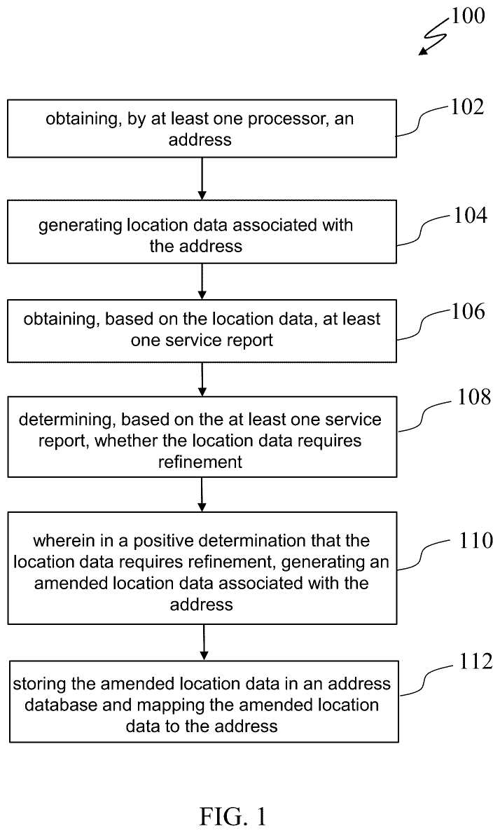

According to an aspect of the disclosure and with reference to FIG. 1, there is provided a method 100 for processing an address, the method comprising the following steps:
Step 102: obtaining, by at least one processor, the address;
Step 104: generating location data associated with the address;
Step 106: obtaining, based on the location data, at least one service report;
Step 108: determining, based on the at least one service report, whether the location data requires refinement;
Step 110: wherein in a positive determination that the location data requires refinement, generating an amended location data associated with the address.

In some embodiments, the method 100 further comprises Step 112: storing the amended location data in an address database and mapping the amended location data to the address.

In some embodiments, the address may be a text address. The text address may comprise one or more alphanumeric characters. In some embodiments, the text address may be parsed to identify individual elements, including, but not limited to, street name, city, state, postal code, and country.

In some embodiments, the text address may be regularized to a normalized format. The regularizing of the text address may include normalizing the parsed elements, and may include standardizing abbreviations, formats, removal of punctuations, and other variations commonly associated with addresses.

In some embodiments, the at least one service report is a field report or a service fulfilment report of an order, such as an order for one or more goods or services. The field report or service report may include a fulfilment status, for example, a “successfully delivered” status or an “unsuccessfully delivered” status. In some embodiments, each of the at least one service report may be assigned a reliability score. A service report may comprise various input data capable of affecting or influencing the reliability score by itself, and/or in conjunction with one or more other service reports. In some embodiments, the input data may include various components, such as location data (e.g. geolocation data), and the corresponding address. The input data may further include a timestamp, and an identifier associated with the service, such as a courier identifier (ID), a package ID, etc.

In some embodiments, the reliability score may be a weighted sum or weighted average of each component of the input data. In some embodiments, the reliability score may be normalized between a range of 0 to 1. In some embodiments, the reliability score may be regarded as a confidence score.

In some embodiments, a plurality of field reports may be used. For example, five or more service reports may be used based on the same service provider, i.e. a first service provider, the first service provider may have provided a service, for example, a delivery service to the address at least five times. In alternative embodiments, the plurality of field reports may be based on different service providers (e.g. a first service provider and a second service provider) to the same address.

In some embodiments, the reliability score may be generated based on at least one of the following: a first location data obtained from a first service provider and a second location data obtained from a second service provider, the first service provider different from the second service provider, a cross-validation of the location data generated by a third-party geolocation system, and a cross-validation of the location data by a plurality of service providers.

In some embodiments, the method further comprises comparing the reliability score of the field report with a threshold, for example, 0.5. If the reliability score is determined to be lower than the threshold, the at least one service report will be disregarded, i.e. the said field report will not be used for the determination of whether the location data requires refinement.

In some embodiments, the reliability score is generated based on determining an unreliable behavoiur of a service provider associated with the at least one service report, and wherein the unreliable behaviour includes confirming a plurality of address within an unrealistic time period. As a non-limiting example, if a service provider (e.g. a driver) confirms three or more addresses at a same location (within 20 metres) in a very short time interval (e.g. within 2 minutes), the resultant service reports associated may be deemed unreliable and not considered for subsequent determination. In some embodiments, the unreliable behaviour may be based on a number of unsuccessful or failed services over a defined period. A higher number of failed services over the defined period may be indicative of lower reliability score.

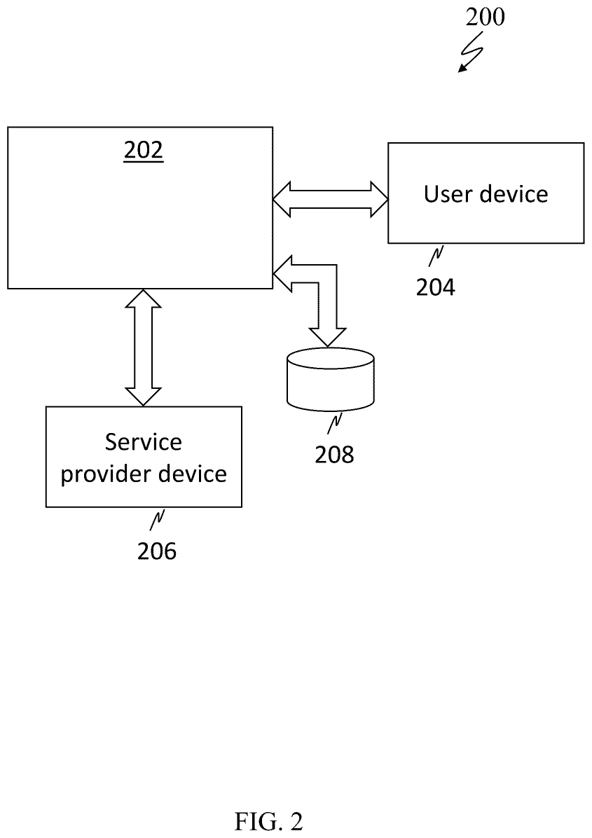

FIG. 2 shows an embodiment of the disclosure, in the form of a system 200 for processing an address. The system 200 may form part of a logistics system, a mapping and navigation system, an e-commerce system, or a social media system. The system 200 may comprise at least one processor 202, the at least one processor 202 configured to receive address information from one or more user devices 204. The at least one processor 202 may be configured to receive service reports from one or more service provider devices 206. The at least one processor 202 may also be configured to receive from an address database 208, address and corresponding location data collected over time.

In some embodiments, the one or more service provider devices 206 may include one or more global positioning system (GPS) enabled mobile devices. The one or more service provider devices 206 may be configured to record location data, e.g. geolocation data associated with an activity or event, such as an indication of successful delivery of a parcel. In some embodiments, the one or more service provider devices 206 may be configured to provide one or more user interfaces, the one or more user interfaces allowing service providers to indicate the status of the activity or event, such as successful delivery, unsuccessful delivery, undetermined address, etc. In some embodiments, such user interface may include one or more questions regarding whether the service provider is at the location of the end customer, and in the event of an abnormal or non-delivery as may be indicated by the service provider, the service provider may be prompted to indicate a reason (e.g. forgot to confirm location, end customer requested a change of location, device issues, etc.)

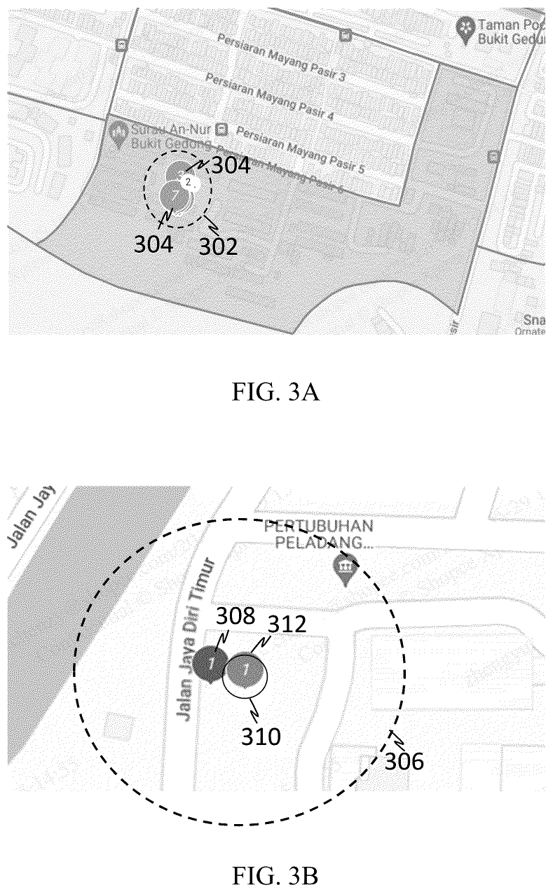

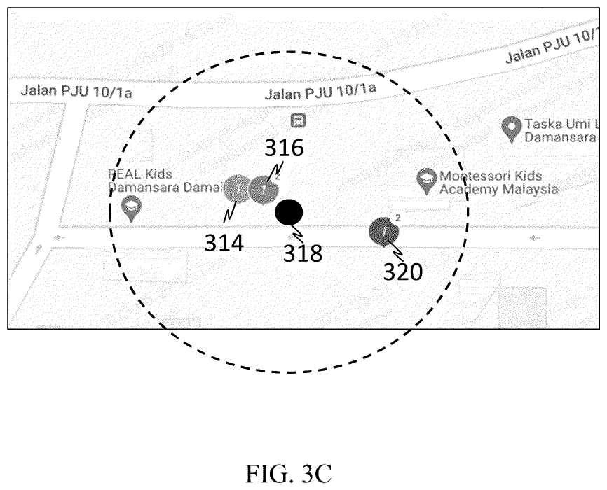

In some embodiments, the at least one processor 202 may be configured to determine whether the location data requires refinement, based on the analysis carried out on one or more service reports, by at least one of three methods as illustrated in FIG. 3A, 3B and 3C. In each of the three methods, reference to “latest order” refers to an input address obtained by the processor 202 that may require refinement of the corresponding location data.

FIG. 3A illustrates a map with geolocation data, the geolocation data comprises a cluster 302 of geolocation pins. The cluster 302 may comprise multiple geolocation pins 304, each geolocation pin 304 associated with a delivery of an order (i.e. delivery service) to the same address. The at least one processor 202 may be configured to:

Determine the number of latest orders to a particular address based on the location data (e.g. geolocation pins), and whether the number of latest orders exceeds a threshold, for example, but not limited to, five (5). In some embodiments, the threshold may be set at 8, 10, or any other number.

In a positive determination that the number of latest orders exceeds the threshold, calculate the distance between the most recent geolocation pin with each of the geolocation pins corresponding to the latest orders.

If the distance is within a pre-determined threshold distance, for example, 100 metres (m), then the location data is deemed to be an accurate location data and no refinement is necessary.

FIG. 3B illustrates a map with geolocation data, the geolocation data comprises a cluster 306 of geolocation pins 308. Each geolocation pin 308 may be associated with a delivery of an order to the same address. The at least one processor 202 may be configured to:

Determine the number of latest orders to a particular address based on the location data (e.g. geolocation pins), and whether the number of latest orders exceed a threshold, for example, five (5).

Calculate a centroid 310 of the cluster 306 of the geolocation pins 308. The centroid 310 may be calculated based on a formula of a circle.

Obtain a reference geolocation pin 312 for comparison with the centroid 310. The reference geolocation pin may be, for example, a Google™ geolocation pin, or any other geolocation pin(s) from other geolocation services.

Calculate the distance between the reference geolocation pin 312 with the centroid 310.

If the distance is within a pre-determined threshold distance, for example, 100 metres (m), then the location data is deemed to be an accurate location data and no refinement is necessary.

FIG. 3C illustrates a map with geolocation data, the geolocation data comprises a plurality of geolocation pins 314, 316. Each geolocation pin 314, 316 may be associated with a different service provider (e.g. different drivers) providing a service, for example, delivery service, to the same address. The at least one processor 202 may be configured to:

Calculate a centroid 318 based on the geolocation pins 314, 316. The centroid 318 may be calculated based on the formula of a circle.

Determine if more than a predetermined percentage (e.g. 80%) of the drivers' centroids are within a defined distance, for example, 100 m, from the latest location data, in the form of a geolocation pin 320, is obtained.

If the distance is within a threshold distance, for example, 100 metres (m), then the location data is deemed to be an accurate location data, and no refinement is deemed necessary.

In each of the aforementioned examples, if the distance measure falls outside the threshold distance, the at least one processor 202 may be configured to refine the location data based on amending the latest location data to, for example, the centroid 310, centroid 318, or the reference geolocation pin 312. In some embodiments, the refinement of the location data may be accompanied by sending a notification to the user to alert the user of the proposed change. In some embodiments, the processor 202 is further configured to perform a geocoding function to convert the normalized elements of the obtained address into geographical coordinates through a geocoding process, utilizing a mapping or geospatial database.

It may be contemplated that various features of the methods as illustrated in FIG. 3A, 3B, and 3C may be combined to form further variations for determining whether the location data or address associated with the “latest order” requires refinement. For example, different weightage may be attributed to each of the methods depicted in FIG. 3A, 3B and 3C to obtain an overall decision to refine the location data which takes into account all the three methods.

In some embodiments, the processor 202 may be configured to extract additional relevant information associated with the address, such as landmarks, neighborhood details, or geospatial context, to enhance the address data.

In some embodiments, the geocoding function may be a reverse geocoding method to map or link an address to a point of interest (POI) data/information in the address database 208 or library. The coordinates, such as the latitude and longitude of the POI, may be used as a reference position of the address.

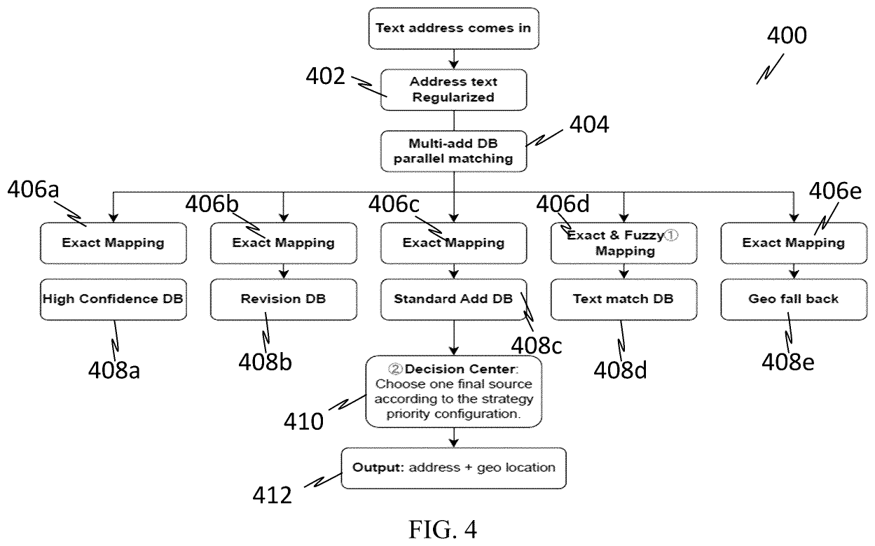

FIG. 4 shows a mapping process 400 of a text address to an output address and geolocation data. Broadly, the mapping process 400 involves regularizing raw address text 402, and multi-address database parallel matching 404, before obtaining the latitude and longitude of the address based on the parallel matching.

Regularizing the raw address text 402 may include various operations converting the raw address text to a normalization case, such as uniform capitalization, remove punctuation and spaces, etc.

Multi-address DB parallel matching may include matching the text address to multiple address libraries in a parallel manner. The parallel matching may include exact mapping modules 406a, 406b, 406c, 406e, and exact and fuzzy matching module 406d.

The exact mapping module 406a may output the mapped/matched data to a high confidence database (DB) module 408a. The exact mapping module 406b may output the mapped/matched data to a Revision database (DB) module 408b. The exact mapping module 406c may output the mapped/matched data to a standard address database (DB) module 408c. The exact and fuzzy matching module 406d may output the mapped/matched data to a text match database (DB) module 408d. The exact mapping module 406e may output the mapped/matched data to a Geo fall-back database (DB) module 408e.

The output of the different databases may be sent to a decision center 410, the decision center 410 may be a module configured to select one final matching source according to a defined strategy. In some embodiments, the decision center 410 may support manual configuration of the matching order of multiple address libraries to achieve the best matching effect based on highest efficiency and coverage rate, and to output the final location data 412. In some embodiments, the defined strategy may be based on a priority scheme wherein the output from the high confidence database (DB) module 408a may be ranked as the highest priority, followed by the Revision database (DB) module 408b, the standard address database (DB) module 408c, the text match database (DB) module 408d, and the Geo fall-back database (DB) module 408e.

In some embodiments, the final location data 412 may comprise the address and the geolocation data in the form of coordinates.

In some embodiments, the exact and fuzzy matching module 406d may be configured to perform fuzzy mapping in the event of involving the use of a term frequency-inverse document frequency (TF-IDF) algorithm or method to determine or find an address with a consistent structure and keywords.

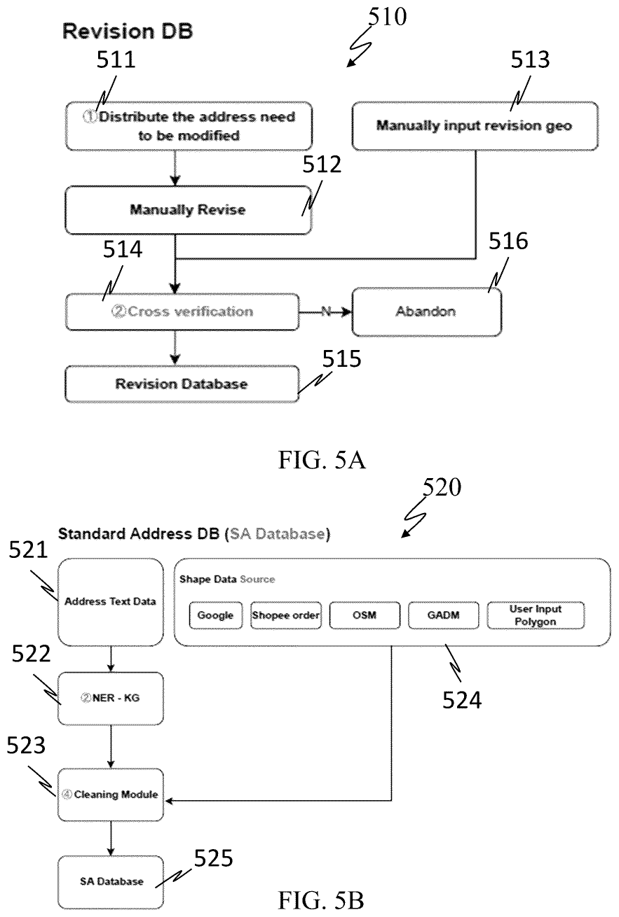

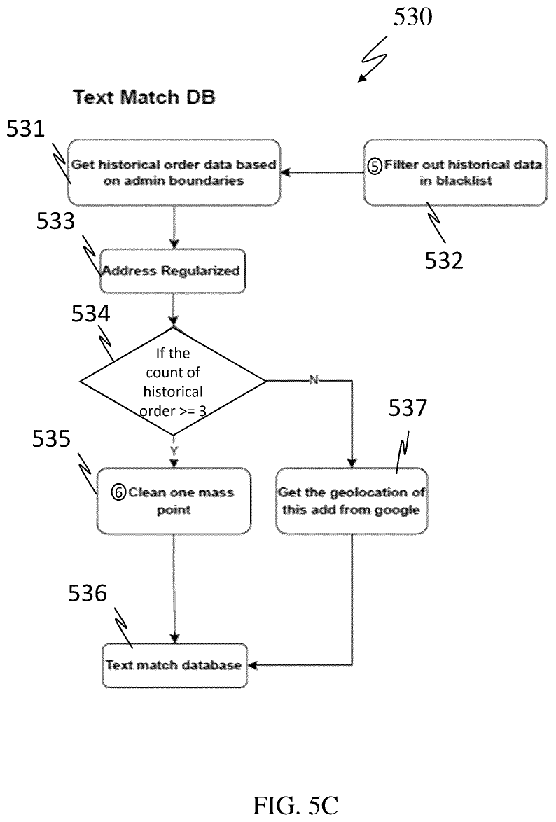

FIG. 5A shows a decision flow process 510 of the revision DB module 408b. The revision DB module 408b may be configured to receive the matched address output from the exact mapping module 406b and may be determined whether the location data is to be revised/modified according to a distribution strategy 511. In some embodiments, the distribution strategy may comprise determining or setting a priority address distribution. This may in turn be based on the frequencies of incorrect service provided (e.g. mis-sorting orders) and the distance between the current/latest address and a reliable service provider geolocation pin, see for example, FIG. 3A, FIG. 3B or FIG. 3C.

The output of the distribution strategy 511 may be sent to a user for manual revision 512. The manual revision 512 may include receiving an input revision geolocation data input 513. The manually revised output may be cross-verified by a cross-verification module 514 to calculate the distance between the revised location data with one or more other associated location data. If the average distance meets an allowable threshold, which may be defined as a constraint, the revised location data passes the verification or check and is stored in a revision database 515. Otherwise, the revised location data is discarded or abandoned 516.

FIG. 5B shows a decision flow process 520 of the standard DB module 408c. The standard DB module 408c may be configured to obtain/receive the regularized address text output from an address text data module 521 and parsed using a NER-KG module 522. The parsing may be based on a named-entity recognition (NER) method to extract key information from the regularized address text. The parsed components may include, for example, street name, community name. The relationship between the different parsed components may be represented using a semantic network, such as a knowledge graph (KG).

The output of the NER-KG module 522 may be sent to a cleaning module 523. The cleaning module 523 may be configured to match the received standard address with the geographical feature or graphics data of the point-of-interest or an area of interest. The cleaning module 523 may be configured to receive shape data from a shape data source 524. Such shape data may be obtained from internal or external sources such as social media, geospatial sources, etc. The output of the cleaning module 523 may be stored in a standard address database 525.

FIG. 5C shows a decision flow process 530 of the text match DB module 408d. The text match DB module 408d may be configured to obtain/receive the historical order data (e.g. service reports from service providers) based on a historical data module 531. In some embodiments, the historical order data module 531 may be obtained based on admin boundaries. Such admin boundaries may be based on a filtering of historical data to remove blacklisted data by a data filter module 532.

In some embodiments, the blacklisted data may include unreliable historical geolocation data derived from certain strategies, including GPS drift data, bad behavior driver data, etc.

The output from the historical data module 531 may undergo address regularization 533. The number of historical orders may be checked 534.

In a positive determination that the number of historical orders are more than a determined threshold, for example, 3, then a geographical center (i.e. centroid) of the location data associated with the number of historical orders may be calculated by a clean one mass point module 535. The output centroid from the module 535 may be stored in a text match database 536.

In a negative determination that the number of historical orders are more than the determined threshold, the location data may be obtained from the reference geolocation pin 537.

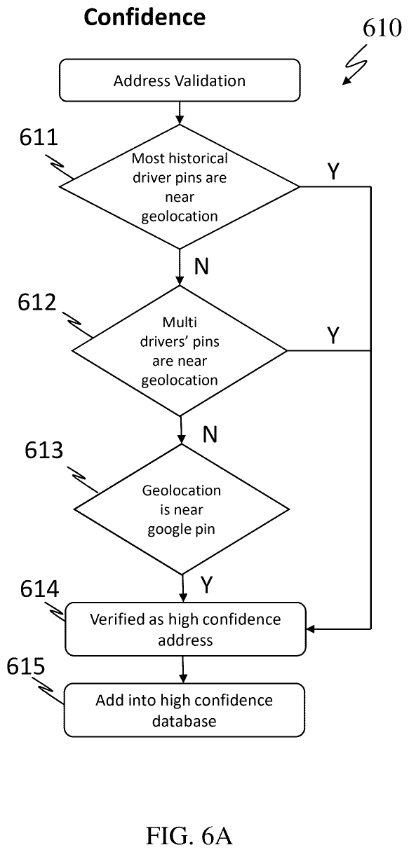

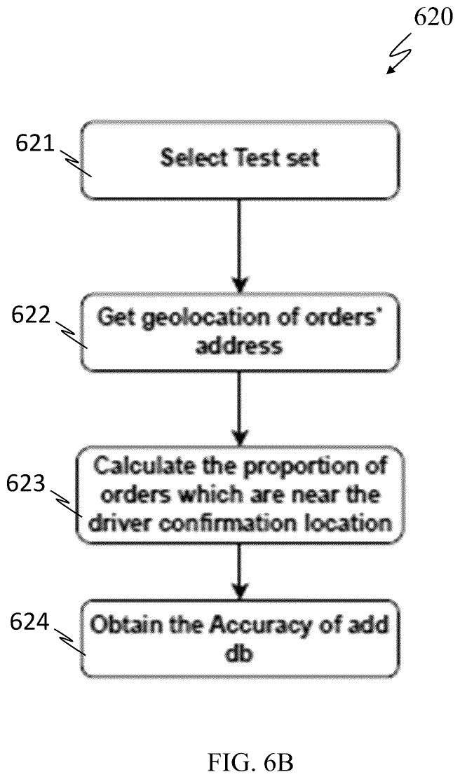

FIG. 6A is a flow chart illustrating a method 610 of evaluating an input location data of an address to determine if it is a high confidence location data and address. An address may be verified as a high confidence address if it is positively determined to meet the criteria of any one of the following decision steps:
Step 611: Majority of the historical geolocation pins are determined to be near or proximate to the input location data. In some embodiments, the proximity may be determined according to FIG. 3A.
Step 612: Multiple service providers' location data are determined to be near or proximate to the input location data. In some embodiments, the proximity may be determined according to FIG. 3C.
Step 613: Input location data is determined to be near or proximate to a reference location data, such as a Google™ geolocation pin. In some embodiments, the proximity may be determined according to FIG. 3B.
Step 614: In a positive determination of at least one of the scenarios described in step 611, 612, or 613, the input location data is determined to be a high confidence address.
Step 615: The high confidence address is stored in a high confidence address database.

FIG. 6B is a flow chart illustrating a method 620 of evaluating or testing accuracy of an input location data, which may be a service provider's current location or address. The testing of accuracy may form part of a quality assurance to validate the accuracy and completeness of a refined location data, ensuring it conforms within a range of tolerable deviations.

The method 620 may comprise the following steps:
Step 621: Select a test set comprising the input location data.
Step 622: Obtain location data (geolocation) of multiple orders' addresses associated with the input location data.
Step 623: calculate a proportion of orders that are near or proximate to the input location data, i.e. the service provider's current location or address.
Step 624: obtain an accuracy measurement based on an address database.

In some embodiments, the processor 202 may be configured to refine the location data based on a refinement Algorithm: Implementing a refinement algorithm to further optimize the processed address based on contextual information, historical data, or user preferences.

In some embodiments, the processor 202 may be configured to provide at least one user interface to interact with the method, allowing users to input, modify, or verify address information during the processing and refining stages.

Storage: Storing the refined address information in a database or memory for subsequent retrieval or analysis.

It is appreciable that the various described data may include real time data and offline data in various formats.

In some embodiments, the method 100 and system 200 may be applied to an electronic commerce (Ecommerce) system for buying and selling goods and services online. The Ecommerce system may comprise a platform for a plurality of sources for goods and services, service providers such as persons with vehicles to provide delivery service, and end customers who place orders of goods or services from the plurality of sources, and have it delivered to them by the service providers. The method 100 and system 200 may be used to refine the location data of addresses of the end customers and/or the sources of goods and services.

According to another aspect of the present disclosure there is provided a location data database, the location data database comprising an input module, the input module configured to obtain an address from a user; a service report module, the service report module configured to, based on the address, generate location data associated with the address; obtain, based on the location data, at least one service report; a refinement module configured to: determine, based on the at least one service report, whether the location data requires refinement; wherein in a positive determination that the location data requires refinement, generating an amended location data associated with the address.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

Illustrative examples of the disclosure include:

Aspect 1. A method for processing an address, the method comprising: obtaining, by at least one processor, the address; generating location data associated with the address; obtaining, based on the location data, at least one service report; determining, based on the at least one service report, whether the location data requires refinement; wherein in a positive determination that the location data requires refinement, generating an amended location data associated with the address.

Aspect 2. The method of Aspect 1, further comprises storing the amended location data in an address database and mapping the amended location data to the address.

Aspect 3. The method of any of Aspects 1 to 2, further comprises determining a reliability score of the at least one service report before determining whether the location data requires refinement.

Aspect 4. The method of Aspect 3, further comprises comparing the reliability score of the at least one service report with a threshold, wherein in a positive determination that the reliability score is lower than the threshold, the at least one service report is disregarded.

Aspect 5. The method of any of Aspects 3 to 4, wherein the reliability score is generated based on determining an unreliable behaviour of a service provider associated with the at least one service report, and wherein the unreliable behaviour includes confirming a plurality of address within a unrealistic time period.

Aspect 6. The method of any one of the preceding claims, wherein the address is a text address.

Aspect 7. The method of Aspect 6, further comprises regularizing the text address to a normalized format.

Aspect 8. The method of any one of the preceding claims, wherein the location data comprises geolocation data.

Aspect 9. The method of any one of the preceding claims, wherein the determining, based on the at least one service report, whether the location data requires refinement is based on at least one of the following: a first location data obtained from a first service provider and a second location data obtained from a second service provider, the first service provider different from the second service provider, a cross-validation of the location data generated by a third-party geolocation system, and a cross-validation of the location data by a plurality of service providers.

Aspect 10. The method of any one of the preceding claims, wherein generating location data associated with the address comprises inputting the address to an address reverse geocoding module, the address reverse geocoding module configured to generate the location data associated with the address.

Aspect 11. A system for processing an address, the system comprises at least one processor configured to: obtain the address; generate location data associated with the address; obtain, based on the location data, at least one service report; determine, based on the at least one service report, whether the location data requires refinement; wherein in a positive determination that the location data requires refinement, generating an amended location data associated with the address.

Aspect 12. The system of Aspect 11, wherein the at least one processor is configured to: store the amended location data in an address database and map the amended location data to the address.

Aspect 13. The system of any of Aspects 11 to 12, wherein the at least one processor is configured to determine a reliability score of the at least one service report before determining whether the location data requires refinement.

Aspect 14. The system of Aspect 13, wherein the at least one processor is configured to compare the reliability score of the at least one service report with a threshold, wherein in a positive determination that the reliability score is lower than the threshold, the at least one service report is disregarded.

Aspect 15. The system of any of Aspects 13 to 14, wherein the reliability score is generated based on determining an unreliable behaviour of a service provider associated with the at least one service report, and wherein the unreliable behaviour includes confirming a plurality of address within a unrealistic time period.

Aspect 16. The system of any one of the claims 11 to 15, wherein the address is a text address.

Aspect 17. The system of Aspect 16, wherein the at least one processor is configured to regularize the text address to a normalized format.

Aspect 18. The system of any one of claims 11 to 17, wherein the location data comprises geolocation data.

Aspect 19. The system of any of Aspects 13 to 17, wherein the determination, based on the at least one service report, whether the location data requires refinement is based on at least one of the following: a first location data obtained from a first service provider and a second location data obtained from a second service provider, the first service provider different from the second service provider, a cross-validation of the location data generated by a third-party geolocation system, and a cross-validation of the location data by a plurality of service providers.

Aspect 20. The system of any one of claims 11 to 19, wherein the at least one processor is configured to generate location data associated with the address by inputting the address to an address reverse geocoding module, the address reverse geocoding module configured to generate the location data associated with the address.

Aspect 21. A location data database, the location data database comprising an input module, the input module configured to obtain an address from a user; a service report module, the service report module configured, based on the address, generate location data associated with the address; obtain, based on the location data, at least one service report; a refinement module configured to: determine, based on the at least one service report, whether the location data requires refinement; wherein in a positive determination that the location data requires refinement, generating an amended location data associated with the address.

Aspect 22. The location database of Aspect 21, further comprising a network interface configured to interface with at least one of a logistics, mapping and navigation, e-commerce, or social media system.

Aspect 23. A computer program element comprising program instructions, which, when executed by one or more processors, cause the one or more processors to perform the method of any one of Aspects 1 to 10.

Aspect 24. A computer-readable medium comprising program instructions, which, when executed by one or more processors, cause the one or more processors to perform the method of any one of Aspects 1 to 10.

What is claimed is:

1. A method for processing an address, the method comprising:
obtaining, by at least one processor, an address;
generating location data associated with the address;
obtaining at least one service report based on the location data;
determining whether the location data requires refinement based on the at least one service report; and
generating an amended location data associated with the address based on determining the location data requires refinement.

2. The method of claim 1, further comprising:
storing the amended location data in an address database; and
mapping the amended location data to the address.

3. The method of claim 1, further comprising:
determining a reliability score of the at least one service report before determining whether the location data requires refinement.

4. The method of claim 3, further comprising:
comparing the reliability score of the at least one service report with a threshold; and
disregarding the at least one service report based on the reliability score being lower than the threshold.

5. The method of claim 3, wherein the reliability score of the at least one service report is determined based on determining an unreliable behaviour of a service provider associated with the at least one service report, and wherein the unreliable behaviour includes determining a time associated with confirming a plurality of addresses is within a predetermined time range associated with an unrealistic time period.

6. The method of claim 1, wherein the address is a text address.

7. The method of claim 6, further comprising:
regularizing the text address to a normalized format.

8. The method of claim 1, wherein the location data comprises geolocation data.

9. The method of claim 1, wherein determining whether the location data requires refinement is based on at least one of a first location data obtained from a first service provider and a second location data obtained from a second service provider, the first service provider being different from the second service provider, a cross-validation of the location data generated by a third-party geolocation system, a cross-validation of the location data by a plurality of service providers, or any combination thereof.

10. The method of claim 1, wherein generating the location data associated with the address comprises inputting the address to an address reverse geocoding module, the address reverse geocoding module configured to generate the location data associated with the address.

11. A system for processing an address, the system comprises:
at least one memory storing instructions; and
at least one processor coupled to the at least one memory, the at least one processor is configured to execute the instructions to:
obtain an address;
generate location data associated with the address;
obtain at least one service report based on the location data;
determine whether the location data requires refinement based on the at least one service report; and
generate an amended location data associated with the address based on determining the location data requires refinement.

12. The system of claim 11, wherein the at least one processor is further configured to execute the instructions to:
store the amended location data in an address database; and
map the amended location data to the address.

13. The system of claim 11, wherein the at least one processor is further configured to execute the instructions to:
determine a reliability score of the at least one service report before determining whether the location data requires refinement.

14. The system of claim 13, wherein the at least one processor is further configured to execute the instructions to:
compare the reliability score of the at least one service report with a threshold; and
disregard the at least one service report based on the reliability score being lower than the threshold, the at least one service report is disregarded.

15. The system of claim 13, wherein to determine the reliability score of the at least one service report the at least one processor is configured to execute the instructions to:
Determine the reliability score of the at least one service report based on determining an unreliable behaviour of a service provider associated with the at least one service report, and wherein the unreliable behaviour includes determining a time associated with confirming a plurality of addresses is within a predetermined time range associated with an unrealistic time period.

16. The system of claim 11, wherein the address is a text address.

17. The system of claim 16, wherein the at least one processor is further configured to execute the instructions to:
regularize the text address to a normalized format.

18. The system of claim 11, wherein the location data comprises geolocation data.

19. The system of claim 11, wherein to determine whether the location data requires refinement, the at least one processor is configured to execute the instructions to:
determine whether the location data requires refinement based on at least one a first location data obtained from a first service provider and a second location data obtained from a second service provider, the first service provider being different from the second service provider, a cross-validation of the location data generated by a third-party geolocation system, a cross-validation of the location data by a plurality of service providers, or any combination thereof.

20. A non-transitory computer-readable medium comprising program instructions, which, when executed by one or more processors, cause the one or more processors to perform operations comprising:
obtaining, by the one or more processors, an address;
generating location data associated with the address;
obtaining at least one service report based on the location data;
determining whether the location data requires refinement based on the at least one service report; and
generating an amended location data associated with the address based on determining the location data requires refinement.
